(19) United States
(12) Patent Application Publication
(10) Pub. No.: US 2025/0379531 A1
(43) Pub. Date: Dec. 11, 2025

(54) DUAL-AXIS SIMULTANEOUS MOTION SYSTEM BASED ON ENCODER COMPENSATION

(71) Applicant: Delta Electronics, Inc., Taoyuan City (TW)

(72) Inventors: Chi-Huan Shao, Taoyuan City (TW); Cheng-Hao Huang, Taoyuan City (TW); Yen-Po Wang, Taoyuan City (TW)

(21) Appl. No.: 18/771,881

(22) Filed: Jul. 12, 2024

(30) Foreign Application Priority Data
Jun. 6, 2024 (CN) 202410729008.5

(51) Int. Cl. H02P 21/00; H02K 11/215

(52) U.S. Cl. CPC H02P 21/0007; H02K 11/215

(57) ABSTRACT

A dual-axis simultaneous motion system is disclosed and includes a first-axis sliding module, a second-axis sliding module, a transverse beam, a bearing, an encoder and a control unit. A first driver of the first-axis sliding module drives a first sliding block to slide. A second driver of the second-axis sliding module drives a second sliding block to slide. The transverse beam is connected to the first sliding block and the second sliding block. The bearing is pivotally connected between the transverse beam and the first or second sliding block. The encoder is configured to measure an angle of the transverse beam relative to the first or second sliding block. The control unit is connected to the first driver, the second driver and the encoder, and controls the first and second driver based on the encoder compensation, so that the first and second sliding blocks drive the transverse beam to slide.

### CROSS-REFERENCE TO RELATED APPLICATION

This application also claims priority to China Patent Application No. 202410729008.5, filed on Jun. 6, 2024. The entireties of the above-mentioned patent application are incorporated herein by reference for all purposes.

### FIELD OF THE INVENTION

The present disclosure relates to a dual-axis simultaneous motion system, and more particularly to a dual-axis simultaneous motion system based on encoder compensation, acquiring the rotational angle changes of the transverse axis relative to the dual axes through the bearing and the encoder, so as to optimize the control of the dual-axis simultaneous motion, increase the speed and solving the vibration problem caused by controlling the dual-axis simultaneous motion.

### BACKGROUND OF THE INVENTION

Generally speaking, the gantry dual-axis simultaneous motion system is used in a variety of industrial processes. By means of structural supporting or pin positioning at both ends of the transverse axis, the structure has the two ends of the transverse axis fixed to two sets of parallel driving modules with bolts to limit its degree of freedom. In that, two sets of parallel driving modules are cooperated to jointly drive the middle transverse axis in a single feed motion.

However, the dual-axis simultaneous motion system is easily affected by errors in assembly and processing accuracy, which leads to an increase in internal stress and resistance during the operation of the assembled system. In that, the control results of the driving modules are affected, the vibration is generated, and the positioning performance is further affected.

On the other hand, the fixed connection method between the transverse axis and the driving modules is not conducive to the external sensing method. Therefore, the true status of the system operation cannot be obtained. It can only be indirectly judged from the motor current and other values of the driving modules. It fails to achieve an optimal control of the system.

Therefore, there is a need of providing a dual-axis simultaneous motion system based on encoder compensation, acquiring the rotational angle changes of the transverse axis relative to the dual axes through the bearing and the encoder, so as to optimize the control of the dual simultaneous motion, increase the speed, solve the vibration problem caused by controlling the dual-axis simultaneous motion, and obviate the drawbacks encountered by the prior arts.

### SUMMARY OF THE INVENTION

An object of the present disclosure is to provide a dual-axis simultaneous motion system based on encoder compensation, acquiring the rotational angle changes of the transverse beam relative to the dual axes through the bearing and the encoder, so as to optimize the control of the dual simultaneous motion, increase the speed and improve the vibration problem of the dual simultaneous motion.

Another object of the present disclosure is to provide a dual-axis simultaneous motion system based on encoder compensation. The bearing and the encoder are provided to measure the changes of the transverse beam relative to the two axes. The displacement and the internal stress of the transverse beam are instantly determined by the measured value of the encoder. The control unit controls the drivers on the two axes according to the measured value of the encoder to move in a steady state, so that the rotational angle, the distortion degree and the instant measured value tend to zero. It helps to achieve the purpose of optimizing the control of the dual-axis simultaneous motion. The installation of the bearing and the encoder is not limited to one or both ends of the transverse beam. The inner ring and the outer ring of the bearing can be installed by connecting the protrusion of the sliding block and the sleeve opening of the transverse beam, and then the encoder is disposed correspondingly. The control of the dual-axis simultaneous motion system can be optimized through the compact structure, the entire operating speed can be improved, and the vibration problem caused by controlling the dual-axis simultaneous motion can be solved.

In accordance with an aspect of the present disclosure, a dual-axis simultaneous motion system based on encoder compensation is provided. The dual-axis simultaneous motion system based on encoder compensation includes a first-axis sliding module, a second-axis sliding module, a transverse beam, a bearing, an encoder and a control unit. The first-axis sliding module includes a first sliding block, a first sliding rail and a first diver, wherein the first driver drives the first sliding block to slide on the first sliding rail. The second-axis sliding module includes a second sliding block, a second sliding rail and a second driver, wherein the second driver drives the second sliding block to slide on the second sliding rail. The transverse beam includes a first end and a second end opposite to each other, wherein the first end and the second end are connected to the first sliding block and the second sliding block, respectively. The bearing is pivotally connected between the first end and the first sliding block or between the second end and the second sliding block. The encoder is spatially corresponding to the bearing and configured to measure a rotational angle of the first end of the transverse beam relative to the first sliding block or of the second end of the transverse beam relative to the second sliding block. The control unit is connected to the first driver, the second driver and the encoder, and controls the first driver and the second driver based on the rotational angle, so that the first sliding block and the second sliding block drive the transverse beam to slide.

In an embodiment, the control unit receives the rotational angle and performs a difference calculation, so as to determine a displacement and an internal stress of the transverse beam and control the first driver and the second driver.

In an embodiment, the control unit controls the first driver and the second driver to move in a steady state, and a change value of the rotational angle tends to zero.

In an embodiment, the encoder measures the rotational angle to have a position-measured value, and an offset-measured value is measured by the encoder when the transverse beam moves relative to the first sliding rail or the second sliding rail, wherein the control unit estimates a distortion degree of the first end or the second end based on the difference between the offset-measured value and the position-measured value, wherein the control unit controls the first driver and the second driver to move in a steady state, and the distortion degree tends to zero.

In an embodiment, the first-axis sliding module includes a first-driver-position encoder, the second-axis sliding module includes a second-driver-position encoder, and the control unit includes a main controller, a position controller, and a speed controller, wherein the speed controller is connected to the first driver or the second driver, and the main controller is connected to the encoder, the first-driver-position encoder and the second-driver-position encoder, wherein the main controller drives the speed controller according to a position difference obtained by the first-driver-position encoder and the second-driver-position encoder and the position-measured value to control the first driver or the second driver.

In an embodiment, the control unit includes a compensator receiving the rotational angle and a predetermined adjustment value, respectively, to control the first driver and the second driver.

In an embodiment, the dual-axis simultaneous motion system based on encoder compensation further includes a transverse sliding module including a third sliding block, a third sliding rail and a third driver, wherein the third driver drives the third sliding block to slide on the third sliding rail.

In accordance with another aspect of the present disclosure, a dual-axis simultaneous motion system based on encoder compensation is provided. The dual-axis simultaneous motion system based on encoder compensation includes a first-axis sliding module, a second-axis sliding module, a transverse beam, a first bearing, a first encoder, a second bearing, a second encoder and a control unit. The first-axis sliding module includes a first sliding block, a first sliding rail and a first diver, wherein the first driver drives the first sliding block to slide on the first sliding rail. The second-axis sliding module includes a second sliding block, a second sliding rail and a second driver, wherein the second driver drives the second sliding block to slide on the second sliding rail. The transverse beam includes a first end and a second end opposite to each other, wherein the first end and the second end are connected to the first sliding block and the second sliding block, respectively. The first bearing is pivotally connected between the first end and the first sliding block. The first encoder is spatially corresponding to the first bearing and configured to measure a first rotational angle of the first end of the transverse beam relative to the first sliding block. The second bearing is pivotally connected between the second end and the second sliding block. The second encoder is spatially corresponding to the second bearing and configured to measure a second rotational angle of the second end of the transverse beam relative to the second sliding block. The control unit is connected to the first driver, the second driver, the first encoder and the second encoder, and controls the first driver and the second driver based on the first rotational angle and the second rotational angle, so that the first sliding block and the second sliding block drive the transverse beam to slide.

In an embodiment, the control unit receives the first rotational angle and the second rotational angle, and performs a difference calculation, so as to determine a displacement and an internal stress of the transverse beam and control the first driver and the second driver.

In an embodiment, the control unit controls the first driver and the second driver to move in a steady state, and a change value of the first rotational angle and a change value of the second rotational angle tend to zero.

In an embodiment, the first encoder measures the first rotational angle to have a first position-measured value, and a first offset-measured value is measured by the first encoder when the first end of the transverse beam moves relative to the first sliding rail at a first moving speed, wherein the control unit estimates a first distortion degree of the first end based on the difference between the first offset-measured value and the first position-measured value, wherein the second encoder measures the second rotational angle to have a second position-measured value, and a second offset-measured value is measured by the second encoder when the second end of the transverse beam moves relative to the second sliding rail at a second moving speed, wherein the control unit estimates a second distortion degree of the second end based on the difference between the second offset-measured value and the second position-measured value.

In an embodiment, the control unit controls the first driver and the second driver to move in a steady state, and the first distortion degree and the second distortion degree tend to zero.

In an embodiment, the control unit includes a compensator receiving the first position-measured value and the second position-measured value, calculating the first distortion degree and the second distortion degree, and receiving a predetermined adjustment value, so as to control the first driver and the second driver.

In an embodiment, the first-axis sliding module includes a first-driver-position encoder, the second-axis sliding module includes a second-driver-position encoder, and the control unit includes a first main controller, a first position controller, a first speed controller, a second main controller, a second position controller and a second speed controller, wherein the first speed controller is connected to the first driver, and the first main controller is connected to the first encoder, the first-driver-position encoder and the second-driver-position encoder, wherein the first main controller drives the first speed controller according to a position difference obtained by the first-driver-position encoder and the second-driver-position encoder and the first position-measured value to control the first driver, wherein the second speed controller is connected to the second driver, and the second main controller is connected to the second encoder, the first-driver-position encoder and the second-driver-position encoder, wherein the second main controller drives the second speed controller according to the position difference obtained by the first-driver-position encoder and the second-driver-position encoder and the second position-measured value to control the second driver.

In an embodiment, the transverse beam includes a first sleeve opening and a second sleeve opening disposed adjacent to the first end and the second end, respectively, wherein the first sliding block further includes a first protrusion passing through the first sleeve opening, an inner ring of the first bearing is connected to the first protrusion, and an outer ring of the first bearing is connected to the first sleeve opening, wherein the second sliding block further comprises a second protrusion passing through the second sleeve opening, an inner ring of the second bearing is connected to the second protrusion, and an outer ring of the second bearing is connected to the second sleeve opening.

In an embodiment, the dual-axis simultaneous motion system based on encoder compensation further includes a transverse sliding module including a third sliding block, a third sliding rail and a third driver, wherein the third driver drives the third sliding block to slide on the third sliding rail.

### BRIEF DESCRIPTION OF THE DRAWINGS

The above contents of the present disclosure will become more readily apparent to those ordinarily skilled in the art after reviewing the following detailed description and accompanying drawings, in which:

FIG. 1 is a schematic perspective view illustrating a dual-axis simultaneous motion system according to a first embodiment of the present disclosure;

FIG. 2 is a cross-sectional structural view illustrating the dual-axis simultaneous motion system according to the first embodiment of the present disclosure;

FIG. 3 is a control block diagram illustrating the dual-axis simultaneous motion system according to the first embodiment of the present disclosure;

FIG. 4 is a schematic diagram illustrating a rotational angle measured by the encoder at an initial position in the dual-axis simultaneous motion system according to the first embodiment of the present disclosure;

FIG. 5 is a schematic diagram illustrating a rotational angle measured by the encoder after movement in the dual-axis simultaneous motion system according to the first embodiment of the present disclosure;

FIG. 6 is a compensation operation logic diagram of the dual-axis simultaneous motion system according to the first embodiment of the present disclosure;

FIG. 7 is a schematic diagram illustrating a position-measured value of the encoder at an initial position in the dual-axis simultaneous motion system according to the first embodiment of the present disclosure;

FIG. 8 is a schematic diagram illustrating a position-measured value of the encoder after movement in the dual-axis simultaneous motion system according to the first embodiment of the present disclosure;

FIG. 9 is a control logic diagram of the dual-axis simultaneous motion system according to the first embodiment of the present disclosure;

FIG. 10 is a schematic perspective view illustrating a dual-axis simultaneous motion system according to a second embodiment of the present disclosure;

FIG. 11 is a cross-sectional structural view illustrating the dual-axis simultaneous motion system according to the second embodiment of the present disclosure;

FIG. 12 is a schematic diagram illustrating a position-measured value of the encoder at an initial position in the dual-axis simultaneous motion system according to the second embodiment of the present disclosure;

FIG. 13 is a schematic diagram illustrating a position-measured value of the encoder after movement in the dual-axis simultaneous motion system according to the second embodiment of the present disclosure; and

FIG. 14 is a control logic diagram of the dual-axis simultaneous motion system according to the second embodiment of the present disclosure.

### DETAILED DESCRIPTION OF THE PREFERRED EMBODIMENT

The present disclosure will now be described more specifically with reference to the following embodiments. It is to be noted that the following descriptions of preferred embodiments of this disclosure are presented herein for purpose of illustration and description only. It is not intended to be exhaustive or to be limited to the precise form disclosed. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed. Further, spatially relative terms, such as “front,” “rear,” “upper,” “lower,” “left,” “right” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly. When an element is referred to as being “connected,” or “coupled,” to another element, it can be directly connected or coupled to the other element or intervening elements may be present. Although the wide numerical ranges and parameters of the present disclosure are approximations, numerical values are set forth in the specific examples as precisely as possible. In addition, although the “first,” “second, and the like terms in the claims be used to describe the various elements can be appreciated, these elements should not be limited by these terms, and these elements are described in the respective embodiments are used to express the different reference numerals, these terms are only used to distinguish one element from another element. For example, a first element could be termed a second element, and, similarly, a second element could be termed a first element, without departing from the scope of example embodiments.

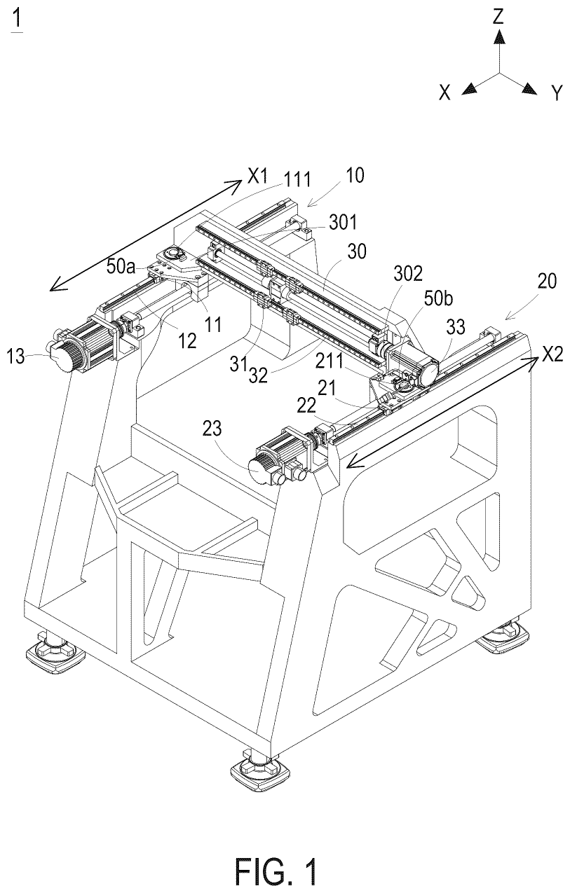

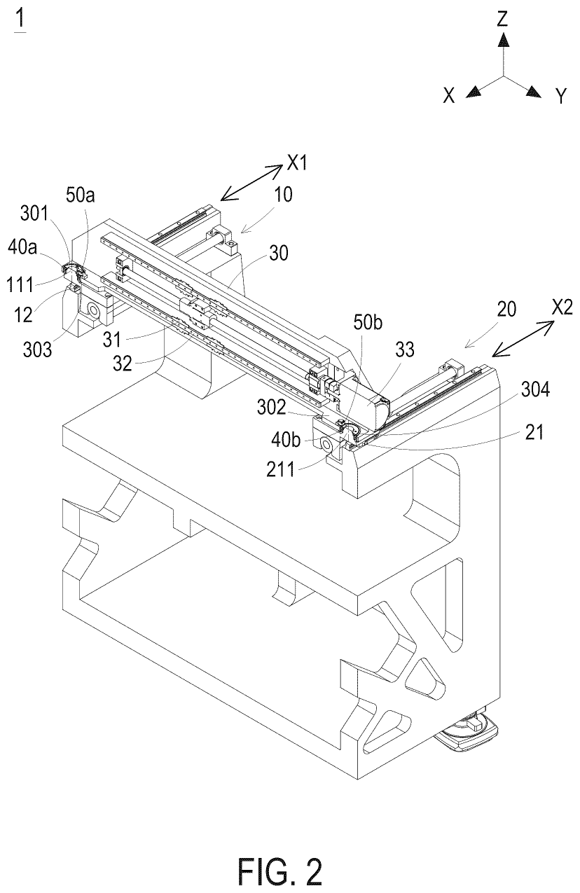

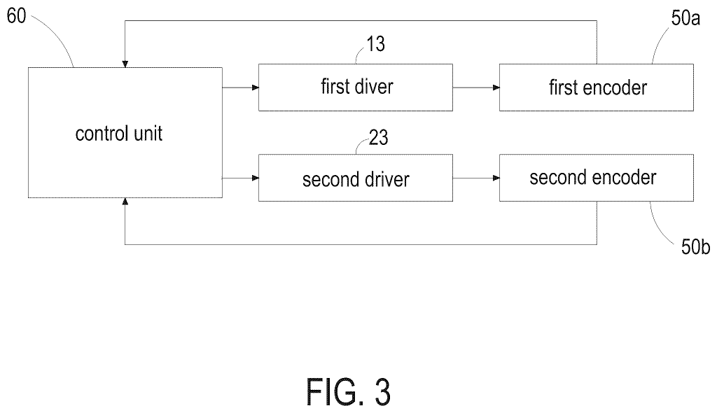

FIG. 1 is a schematic perspective view illustrating a dual-axis simultaneous motion system according to a first embodiment of the present disclosure. FIG. 2 is a cross-sectional structural view illustrating the dual-axis simultaneous motion system according to the first embodiment of the present disclosure. FIG. 3 is a control block diagram illustrating the dual-axis simultaneous motion system according to the first embodiment of the present disclosure. Please refer to FIG. 1 to FIG. 3. A dual-axis simultaneous motion system 1 based on encoder compensation is provided in the present disclosure. Preferably, the dual-axis simultaneous motion system 1 can be applied to for example but not limited to a crane system. In the embodiment, the dual-axis simultaneous motion system 1 includes a first-axis sliding module 10, a second-axis sliding module 20, a transverse beam 30, a first bearing 40a, a first encoder 50a, a second bearing 40b, a second encoder 50b and a control unit 60. The first-axis sliding module 10 includes a first sliding block 11, a first sliding rail 12 and a first diver 13. In the embodiment, the first driver 13 drives the first sliding block 11 to slide on the first sliding rail 12. That is, the first sliding block 11 is driven to slide along the first axial direction X1. The second-axis sliding module 20 includes a second sliding block 21, a second sliding rail 22 and a second driver 23. In the embodiment, the second driver 23 drives the second sliding block 21 to slide on the second sliding rail 22. That is, the second sliding block 21 is driven to slide along the second axial direction X2. Preferably but not exclusively, the first sliding rail 12 and the second sliding rail 22 are parallel to each other. That is, the first axial direction X1 and the second axial direction X2 are both parallel to the X axis. In the embodiment, the transverse beam 30 includes a first end 301 and a second end 302 opposite to each other. The first end 301 and the second end 302 are connected to the first sliding block 11 and the second sliding block 21, respectively. The first bearing 40a is pivotally connected between the first end 301 and the first sliding block 11. The first encoder 50a is spatially corresponding to the first bearing 40a and configured to measure a first rotational angle of the first end 301 of the transverse beam 30 relative to the first sliding block 11. The second bearing 40b is pivotally connected between the second end 302 and the second sliding block 21. The second encoder 50b is spatially corresponding to the second bearing 40b and configured to measure a second rotational angle of the second end 302 of the transverse beam 30 relative to the second sliding block 21. The control unit 60 is connected to the first driver 13, the second driver 23, the first encoder 50a and the second encoder 50b, and controls the first driver 13 and the second driver 23 based on the first rotational angle and the second rotational angle, so that the first sliding block 11 and the second sliding block 21 drive the transverse beam 30 to slide smoothly in the X-axis direction.

Notably, due to the influence of assembling and manufacturing accuracy errors, the sliding of the first sliding block 11 in the first axial direction X1 and the sliding of the second sliding block 21 in the second axial direction X2 may not be performed completely parallel or simultaneously. In the present disclosure, the control unit 60 is provided to receive the first rotational angle measured by the first encoder 50a and the second rotational angle measured by the second encoder 60a, it allows the control unit 60 to perform a difference calculation, so as to determine a displacement and an internal stress of the transverse beam 30 and control the first driver 13 and the second driver 23. Thereby, the control of the dual simultaneous motion is optimized, the entire operation speed is improved, and the vibration problem of the dual simultaneous motion is solved. The compensation operation logic of the control unit 60 will be further described below.

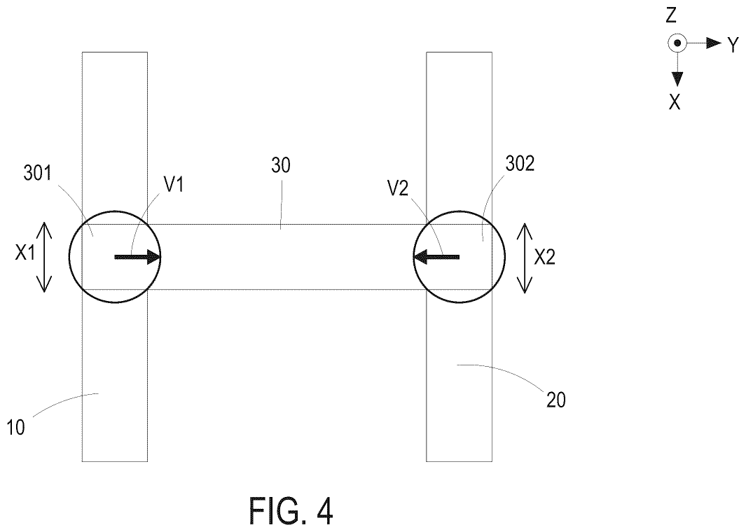

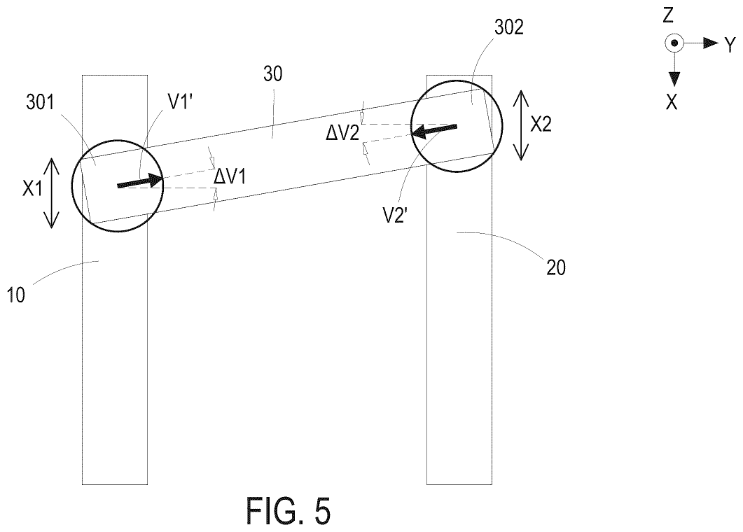

FIG. 4 is a schematic diagram illustrating a rotational angle measured by the encoder at an initial position in the dual-axis simultaneous motion system according to the first embodiment of the present disclosure. FIG. 5 is a schematic diagram illustrating a rotational angle measured by the encoder after movement in the dual-axis simultaneous motion system according to the first embodiment of the present disclosure. Please refer to FIG. 1 to FIG. 5. In an initial state, if the first sliding block 11 and the second sliding block 21 can smoothly drive the transverse beam 30 to slide along the X-axis direction, the control unit 60 receives the first angle-measured value V1 and the second angle-measured value V2, which approach a constant value and will not change, as shown in FIG. 4. However, due to the influence of assembling and manufacturing accuracy errors, when the first sliding block 11 sliding along the first axial direction X1 and the second slider 21 sliding along the second axial direction X2 are not synchronized with each other, the first encoder 50a obtains the first angle-measured value V1′ and the second angle-measured value V2′. Compared with the first angle-measured value V1 and the second angle-measured value V2 obtained in the initial state (or the steady state), the first angle-measured value V1′ obtained by the first encoder 50a and the second angle-measured value V2′ obtained by the second encoder 50b further include a first angle-change value ΔV1 and a second angle-change value ΔV2. At this time, it allows the control unit 60 to determine the displacement and the internal stress of the transverse beam 30 based on the first angle-change value ΔV1 and the second angle-change value ΔV2, and then control the output of the first driver 13 and the second driver 23. Thereby, the first angle-change value ΔV1 or/and the second angle-change value ΔV2 tend to zero, and the steady state motion of the dual-axis simultaneous motion system 1 is restored.

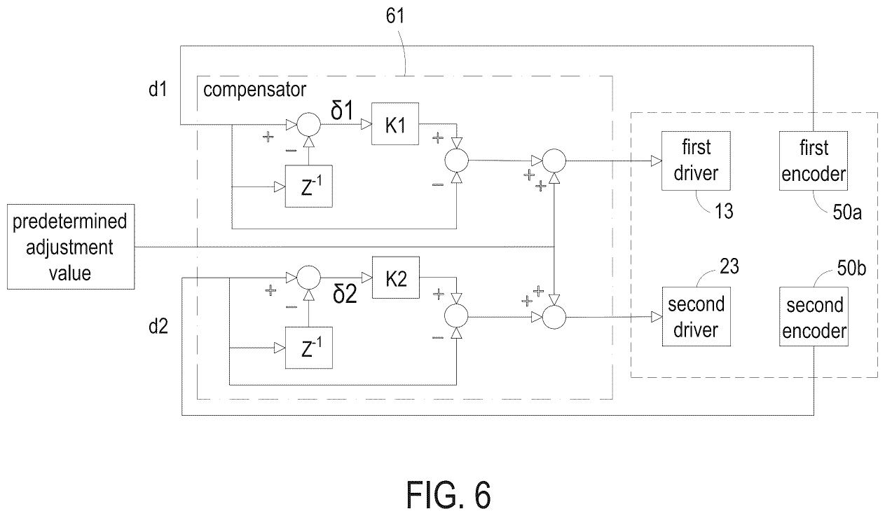

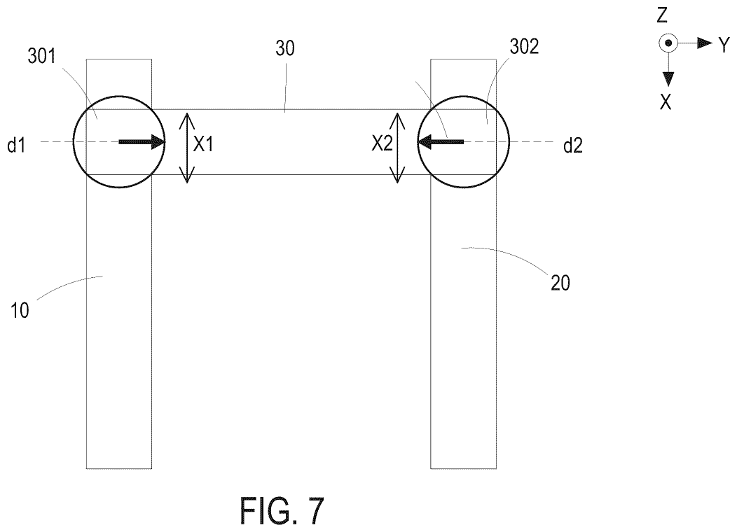

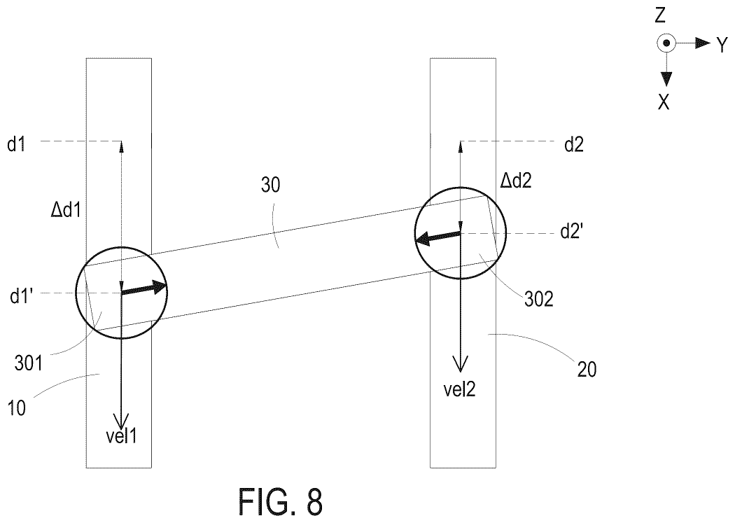

FIG. 6 is a compensation operation logic diagram of the dual-axis simultaneous motion system according to the first embodiment of the present disclosure. FIG. 7 is a schematic diagram illustrating a position-measured value of the encoder at an initial position in the dual-axis simultaneous motion system according to the first embodiment of the present disclosure. FIG. 8 is a schematic diagram illustrating a position-measured value of the encoder after movement in the dual-axis simultaneous motion system according to the first embodiment of the present disclosure. Please refer to FIG. 1 to FIG. 3 and FIG. 6 to FIG. 8. In the embodiment, the control unit 60 for example includes a compensator 61, which is configured to receive the first rotational angle or/and the second rotational angle, respectively, and receive a predetermined adjustment value, so as to control the first driver 13 and the second driver 23, and stabilize the movement of the transverse beam 30 in the first axial direction X1 and the second axial direction X2. In the embodiment, the first encoder 50a is configured to measure the first rotational angle to have a first position-measured value d1. Moreover, a first offset-measured value d1′ is measured by the first encoder 50a when the first end 301 of the transverse beam 30 is moved relative to the first sliding rail 12 at a first moving speed vel1. In the embodiment, it allows the control unit 60 to estimate a first distortion degree δ1 of the first end 301 based on the difference between the first offset-measured value d1′ and the first position-measured value d1, for example through the (Z⁻¹) transform. The first distortion degree δ1 can be adjusted by the gain value K1 and then in accordance with the predetermined adjustment value to control the first driver 13. In case of that the control unit 60 controls the first driver 13 and the second driver 23 to move in a steady state, and the first distortion degree δ1 tends to zero. Similarly, the second encoder 50b measures the second rotational angle to have a second position-measured value d2, and a second offset-measured value d2′ is measured by the second encoder 50b when the second end 302 of the transverse beam 30 moves relative to the second sliding rail 22 at a second moving speed vel2. In the embodiment, it allows the control unit 60 to estimate a second distortion degree δ2 of the second end 302 based on the difference between the second offset-measured value d2′ and the second position-measured value d2, for example through the (Z⁻¹) transform. The second distortion degree δ2 can be adjusted by the gain value K2 and then in accordance with the predetermined adjustment value to control the second driver 23. In case of that the control unit 60 controls the first driver 13 and the second driver 23 to move in a steady state, and the second distortion degree δ2 tends to zero.

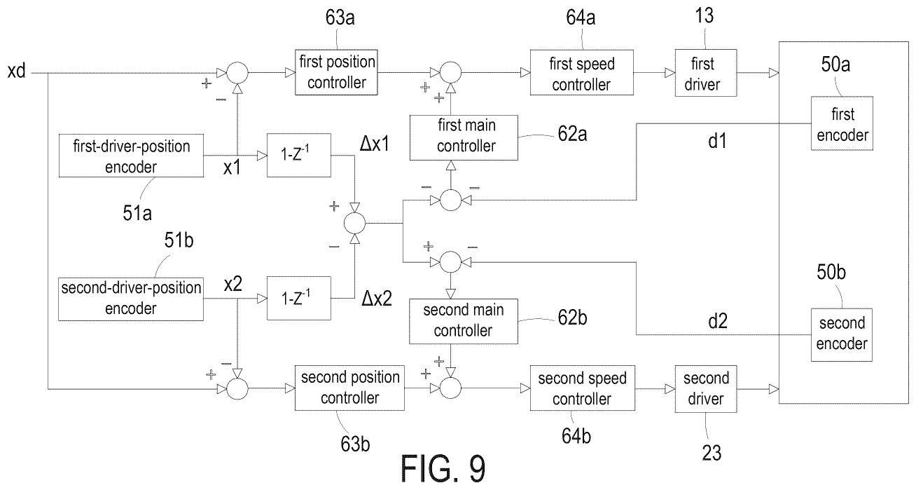

FIG. 9 is a control logic diagram of the dual-axis simultaneous motion system according to the first embodiment of the present disclosure. Please refer to FIG. 1 to FIG. 3 and FIG. 7 to FIG. 9. In the embodiment, the first-axis sliding module 10 includes a first-driver-position encoder 51a, the second-axis sliding module 20 includes a second-driver-position encoder 51b, and the control unit 60 includes a first main controller 62a, a first position controller 63a, a first speed controller 64a, a second main controller 62b, a second position controller 63b and a second speed controller 64b. In the embodiment, the first speed controller 64a is connected to the first driver 13, the first main controller 62a is connected to the first encoder 50a, the first-driver-position encoder 51a and the second-driver-position encoder 51b. Preferably but not exclusively, in the embodiment, the output of the first-driver-position encoder 51a is the position x1 of the first end 301 of the transverse beam 30 in the first axial direction X1. After (1−Z⁻¹) transform, the position difference Δx1 in the first axial direction X1 can be obtained, and further served as an input value of the first main controller 62a and the second main controller 62b. Similarly, the second speed controller 64b is connected to the second driver 23, and the second main controller 62b is connected to the second encoder 50b, the first-driver-position encoder 51a and the second-driver-position encoder 51b. Preferably but not exclusively, in the embodiment, the output of the second-driver-position encoder 51b is the position x2 of the second end 302 of the transverse beam 30 in the second axial direction X2. After (1−Z⁻¹) transform, the position difference Δx2 in the second axial direction X2 can be obtained, and further served as an input value of the first main controller 62a and the second main controller 62b. Thereby, it allows the first main controller 62a to drive the first speed controller 64a according to the position difference Δx1, Δx2 obtained by the first-driver-position encoder 51a and the second-driver-position encoder 51b and the first position-measured value d1, so as to control the first driver 13. The instant first position-measured value d1ₙ can be expressed by the equation (1). In addition, it allows the second main controller 62b to drive the second speed controller 64b according to the position difference Δx1, Δx2 obtained by the first-driver-position encoder 51a and the second-driver-position encoder 51b and the second position-measured value d2, so as to control the second driver 23. The instant second position-measured value d2ₙ can be expressed by the equation (2).

$$\begin{matrix}d {1}_{n} = ( vel {1}_{2} - vel {2}_{n} ) dT + d {1}_{n - 1} \\ = ( x {1}_{n - 1} - x {1}_{n - 2} ) - ( x {2}_{n - 1} - x {2}_{n - 2} ) + d {1}_{n - 1} \\ = Δ x 1 - Δ x 2 + d {1}_{n - 1}\end{matrix} \qquad ( 1 )$$

$$\begin{matrix}d {2}_{n} = ( vel {2}_{2} - vel {1}_{n} ) dT + d {2}_{n - 1} \\ = ( x {2}_{n - 1} - x {2}_{n - 2} ) - ( x {1}_{n - 1} - x {1}_{n - 2} ) + d {2}_{n - 1} \\ = Δ x 2 - Δ x 1 + d {1}_{n - 1} + d {2}_{n - 1}\end{matrix} \qquad ( 2 )$$

When the control unit 60 controls the first driver 13 through the first speed controller 64a and controls the second driver 23 through the second speed controller 64b, the instant first position-measured value d1ₙ and the instant second position-measured value d2ₙ tend to zero. In that, the control of the dual simultaneous motion is optimized, the speed is increased, and the vibration problem of the dual simultaneous motion is improved. In other words, the displacement and the internal stress of the transverse beam 30 can be instantly determined by the measured value of the encoder, and the control unit 60 further controls the drivers on the two axes according to the measured value changes of the encoder, so as to move in a steady state. Consequently, the rotational angle, the distortion degree and the instant measured value tend to zero, and the purpose of optimizing the control of the dual-axis simultaneous motion is achieved. Certainly, in other embodiments, the control unit 60 can further receive a predetermined adjustment value xd to perform the control of the first driver 13 and the second driver 23. The present disclosure is not limited thereto.

Please refer to FIG. 1 and FIG. 2. In the embodiment, the transverse beam 30 includes a first sleeve opening 303 and a second sleeve opening 304 disposed adjacent to the first end 301 and the second end 302, respectively. In the embodiment, the first sliding block 11 further includes a first protrusion 111 passing through the first sleeve opening 303. An inner ring of the first bearing 40a is connected to the first protrusion 111, and an outer ring of the first bearing 40a is connected to the first sleeve opening 303. Thus, the first bearing 40a is pivotally connected between the first end 301 and the first sliding block 11. Furthermore, in the embodiment, the second sliding block 21 further includes a second protrusion 211 passing through the second sleeve opening 304. An inner ring of the second bearing 40b is connected to the second protrusion 211, and an outer ring of the second bearing 40b is connected to the second sleeve opening 304. Thus, the second bearing 40b is pivotally connected between the second end 302 and the second sliding block 21. Certainly, the pivotally connecting methods of the first end 301 and the first sliding block 11 through the first bearing 40a, and the second end 302 and the second sliding block 21 through the second bearing 40b are adjustable according to the practical requirements, and the present disclosure is not limited thereto.

In the embodiment, the dual-axis simultaneous motion system 1 further includes a transverse sliding module, which includes a third sliding block 31, a third sliding rail 32 and a third driver 33. In the embodiment, the third driver 33 drives the third sliding block 31 to slide on the third sliding rail 32. Thereby, the dual-axis simultaneous motion system 1 can perform crane operations, for example. Certainly, the applications of the dual-axis simultaneous motion system 1 of the present disclosure is not limited thereto, and not redundantly described herein.

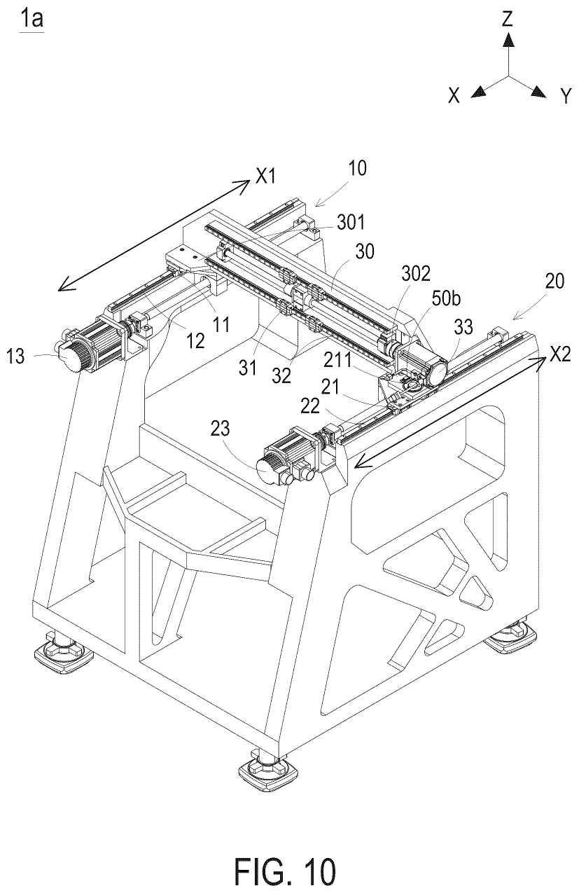

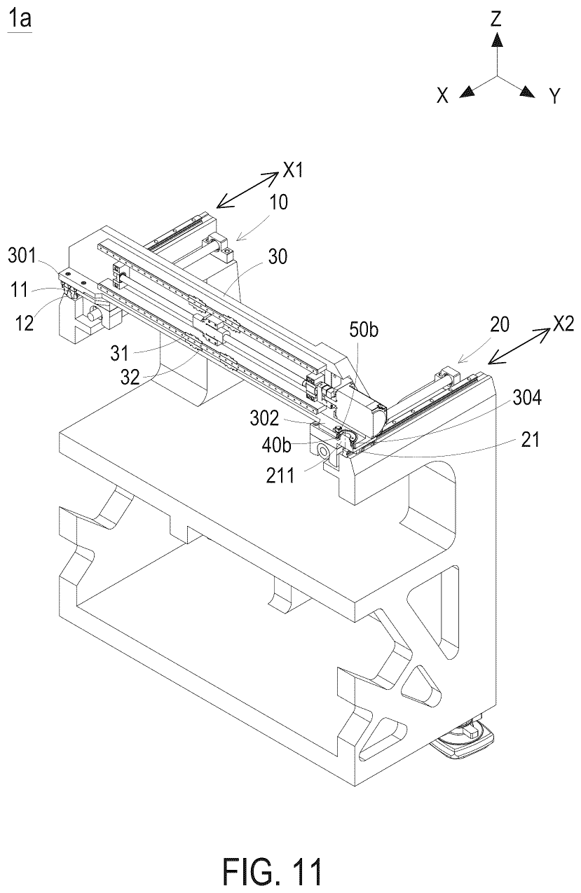

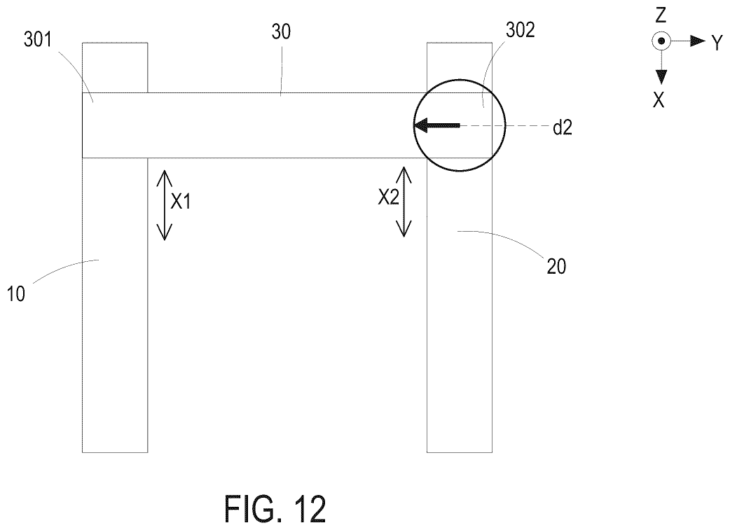

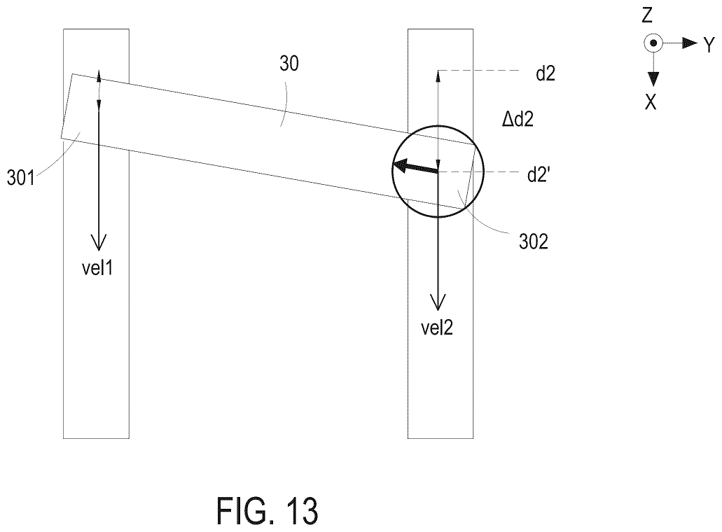

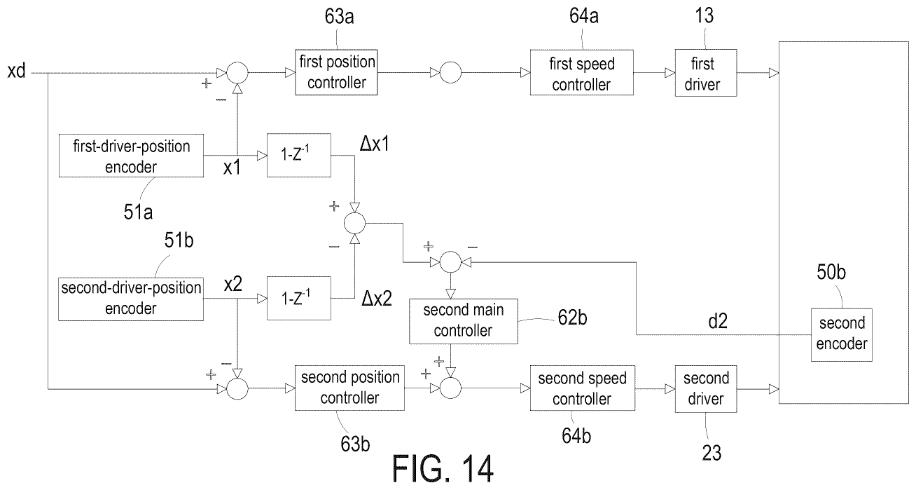

FIG. 10 is a schematic perspective view illustrating a dual-axis simultaneous motion system according to a second embodiment of the present disclosure. FIG. 11 is a cross-sectional structural view illustrating the dual-axis simultaneous motion system according to the second embodiment of the present disclosure. FIG. 12 is a schematic diagram illustrating a position-measured value of the encoder at an initial position in the dual-axis simultaneous motion system according to the second embodiment of the present disclosure. FIG. 13 is a schematic diagram illustrating a position-measured value of the encoder after movement in the dual-axis simultaneous motion system according to the second embodiment of the present disclosure. FIG. 14 is a control logic diagram of the dual-axis simultaneous motion system according to the second embodiment of the present disclosure. In the embodiment, the structures, elements and functions of the dual-axis simultaneous motion system 1a are similar to those of the dual-axis simultaneous motion system 1 of FIG. 1 to FIG. 9, and are not redundantly described herein. In the embodiment, the first end 301 of the transverse beam 30 is fixed to the first sliding block 11 by, for example, a bolting method. Compared with the first embodiment, the first bearing 40a and the first encoder 50a (referring to FIG. 2) are omitted in the dual-axis simultaneous motion system 1a.

Please refer to FIG. 3 and FIG. 10 to FIG. 14. In the embodiment, the first-axis sliding module 10 includes a first-driver-position encoder 51a, and the second-axis sliding module 20 includes a second-driver-position encoder 51b. The control unit 60 includes a first position controller 63a, a first speed controller 64a, a second main controller 62b, a second position controller 63b and a second speed controller 64b. In the embodiment, the first speed controller 64a is connected to the first driver 13, and the first position controller 63a is connected to the first speed controller 64a. Preferably but not exclusively, in the embodiment, the output of the first-driver-position encoder 51a is the position x1 of the first end 301 of the transverse beam 30 in the first axial direction X1. After (1−Z⁻¹) transform, the position difference Δx1 in the first axial direction X1 can be obtained, and further served as an input value of the second main controller 62b. Similarly, the second speed controller 64b is connected to the second driver 23, and the second main controller 62b is connected to the second encoder 50b, the first-driver-position encoder 51a and the second-driver-position encoder 51b. Preferably but not exclusively, in the embodiment, the output of the second-driver-position encoder 51b is the position x2 of the second end 302 of the transverse beam 30 in the second axial direction X2. After (1−Z⁻¹) transform, the position difference Δx2 in the second axial direction X2 can be obtained, and further served as an input value of the second main controller 62b. Thereby, it allows the second main controller 62b to drive the second speed controller 64b according to the position difference Δx1, Δx2 obtained by the first-driver-position encoder 51a and the second-driver-position encoder 51b and the second position-measured value d2, so as to control the second driver 23. The instant second position-measured value d2ₙ can be expressed by the equation (3).

$$\begin{matrix}d {2}_{n} = ( vel {2}_{n} - vel {1}_{n} ) dT + d {2}_{n - 1} \\ = ( x {2}_{n - 1} - x {2}_{n - 2} ) - ( x {1}_{n - 1} - x {1}_{n - 2} ) + d {2}_{n - 1} \\ = Δ x 2 - Δ x 1 + d {2}_{n - 1}\end{matrix} \qquad ( 3 )$$

When the control unit 60 controls the first driver 13 through the first speed controller 64a and controls the second driver 23 through the second speed controller 64b, the instant second position-measured value d2ₙ tends to zero. In that, the control of the dual simultaneous motion is optimized, the speed is increased, and the vibration problem of the dual simultaneous motion is improved. In other words, the displacement and the internal stress of the transverse beam 30 can be instantly determined by the measured value of the encoder disposed at one end, and the control unit 60 further controls the drivers on the two axes according to the measured value changes of the encoder, so as to move in a steady state. Consequently, the rotational angle, the distortion degree and the instant measured value tend to zero, and the purpose of optimizing the control of the dual-axis simultaneous motion is achieved. Certainly, in other embodiments, the control unit 60 can further receive a predetermined adjustment value xd to perform the control of the first driver 13 and the second driver 23. The present disclosure is not limited thereto.

From the above, the dual-axis simultaneous motion system 1, 1a can instantly determine the displace and the internal stress of the transverse beam 30 based on the measured values of the first encoder 50a or/and the second encoder 40b, and it allows the control unit 60 to control the first driver 13 in the first axial direction X1 or/and the second driver 23 in the second axial direction X2, so as to achieve the steady-state movement of the transverse beam 30 along the X-axis direction. Certainly, the arrangements of the bearings and the encoders can be disposed at for example but not limited to one end or two ends. Preferably, the dual-axis simultaneous motion system 1 includes the first bearing 40a and the first encoder 50a disposed at the first end 301 of the transverse beam 30, and includes the second bearing 40b and the second encoder 50b disposed at the second end 302 of the transverse beam 30, so that the measured value changes of the encoders disposed at two opposite ends are utilized to carry out the feedback control, and the control of the dual-axis simultaneous motion is more optimized. Certainly, in other embodiments, even if the first bearing 40a and the first encoder 50a (such as the dual-axis simultaneous motion system 1a) is omitted, or the second bearing 40b and the second encoder 50b is omitted, the feedback control can be carried out based on the measured value changes obtained from one encoder disposed at one end merely. The present disclosure is not limited thereto, and not redundantly described hereafter.

In summary, the present disclosure provides a dual-axis simultaneous motion system based on encoder compensation, acquiring the rotational angle changes of the transverse beam relative to the dual axes through the bearing and the encoder, so as to optimize the control of the dual simultaneous motion, increase the speed and improve the vibration problem of the dual simultaneous motion. The bearing and the encoder are provided to measure the changes of the transverse beam relative to the two axes. The displacement and the internal stress of the transverse beam are instantly determined by the measured value of the encoder. The control unit controls the drivers on the two axes according to the measured value of the encoder to move in a steady state, so that the rotational angle, the distortion degree and the instant measured value tend to zero. It helps to achieve the purpose of optimizing the control of the dual-axis simultaneous motion. The installation of the bearing and the encoder is not limited to one or both ends of the transverse beam. The inner ring and the outer ring of the bearing can be installed by connecting the protrusion of the sliding block and the sleeve opening of the transverse beam, and then the encoder is disposed correspondingly. The control of the dual-axis simultaneous motion system can be optimized through the compact structure, the entire operating speed can be improved, and the vibration problem caused by controlling the dual-axis simultaneous motion can be solved.

While the disclosure has been described in terms of what is presently considered to be the most practical and preferred embodiments, it is intended to cover various modifications and similar arrangements included within the spirit and scope of the appended claims which are to be accorded with the broadest interpretation so as to encompass all such modifications and similar structures.

What is claimed is:

1. A dual-axis simultaneous motion system based on encoder compensation, comprising:
a first-axis sliding module comprising a first sliding block, a first sliding rail and a first diver, wherein the first driver drives the first sliding block to slide on the first sliding rail;
a second-axis sliding module comprising a second sliding block, a second sliding rail and a second driver, wherein the second driver drives the second sliding block to slide on the second sliding rail;
a transverse beam comprising a first end and a second end opposite to each other, wherein the first end and the second end are connected to the first sliding block and the second sliding block, respectively;
a bearing pivotally connected between the first end and the first sliding block or between the second end and the second sliding block;
an encoder spatially corresponding to the bearing and configured to measure a rotational angle of the first end of the transverse beam relative to the first sliding block or of the second end of the transverse beam relative to the second sliding block; and
a control unit connected to the first driver, the second driver and the encoder, and controlling the first driver and the second driver based on the rotational angle, so that the first sliding block and the second sliding block drive the transverse beam to slide.

2. The dual-axis simultaneous motion system based on encoder compensation according to claim 1, wherein the control unit receives the rotational angle and performs a difference calculation, so as to determine a displacement and an internal stress of the transverse beam and control the first driver and the second driver.

3. The dual-axis simultaneous motion system based on encoder compensation according to claim 2, wherein the control unit controls the first driver and the second driver to move in a steady state, and a change value of the rotational angle tends to zero.

4. The dual-axis simultaneous motion system based on encoder compensation according to claim 1, wherein the encoder measures the rotational angle to have a position-measured value, and an offset-measured value is measured by the encoder when the transverse beam moves relative to the first sliding rail or the second sliding rail, wherein the control unit estimates a distortion degree of the first end or the second end based on the difference between the offset-measured value and the position-measured value, wherein the control unit controls the first driver and the second driver to move in a steady state, and the distortion degree tends to zero.

5. The dual-axis simultaneous motion system based on encoder compensation according to claim 4, wherein the first-axis sliding module comprises a first-driver-position encoder, the second-axis sliding module comprises a second-driver-position encoder, and the control unit comprises a main controller, a position controller, and a speed controller, wherein the speed controller is connected to the first driver or the second driver, and the main controller is connected to the encoder, the first-driver-position encoder and the second-driver-position encoder, wherein the main controller drives the speed controller according to a position difference obtained by the first-driver-position encoder and the second-driver-position encoder and the position-measured value to control the first driver or the second driver.

6. The dual-axis simultaneous motion system based on encoder compensation according to claim 1, wherein the control unit comprises a compensator receiving the rotational angle and a predetermined adjustment value, respectively, to control the first driver and the second driver.

7. The dual-axis simultaneous motion system based on encoder compensation according to claim 1, further comprising a transverse sliding module including a third sliding block, a third sliding rail and a third driver, wherein the third driver drives the third sliding block to slide on the third sliding rail.

8. A dual-axis simultaneous motion system based on encoder compensation, comprising:
a first-axis sliding module comprising a first sliding block, a first sliding rail and a first diver, wherein the first driver drives the first sliding block to slide on the first sliding rail;
a second-axis sliding module comprising a second sliding block, a second sliding rail and a second driver, wherein the second driver drives the second sliding block to slide on the second sliding rail;
a transverse beam comprising a first end and a second end opposite to each other, wherein the first end and the second end are connected to the first sliding block and the second sliding block, respectively;
a first bearing pivotally connected between the first end and the first sliding block;
a first encoder spatially corresponding to the first bearing and configured to measure a first rotational angle of the first end of the transverse beam relative to the first sliding block;
a second bearing pivotally connected between the second end and the second sliding block;
a second encoder spatially corresponding to the second bearing and configured to measure a second rotational angle of the second end of the transverse beam relative to the second sliding block; and
a control unit connected to the first driver, the second driver, the first encoder and the second encoder, and controlling the first driver and the second driver based on the first rotational angle and the second rotational angle, so that the first sliding block and the second sliding block drive the transverse beam to slide.

9. The dual-axis simultaneous motion system based on encoder compensation according to claim 8, wherein the control unit receives the first rotational angle and the second rotational angle, and performs a difference calculation, so as to determine a displacement and an internal stress of the transverse beam and control the first driver and the second driver.

10. The dual-axis simultaneous motion system based on encoder compensation according to claim 9, wherein the control unit controls the first driver and the second driver to move in a steady state, and a change value of the first rotational angle and a change value of the second rotational angle tend to zero.

11. The dual-axis simultaneous motion system based on encoder compensation according to claim 8, wherein the first encoder measures the first rotational angle to have a first position-measured value, and a first offset-measured value is measured by the first encoder when the first end of the transverse beam moves relative to the first sliding rail at a first moving speed, wherein the control unit estimates a first distortion degree of the first end based on the difference between the first offset-measured value and the first position-measured value, wherein the second encoder measures the second rotational angle to have a second position-measured value, and a second offset-measured value is measured by the second encoder when the second end of the transverse beam moves relative to the second sliding rail at a second moving speed, wherein the control unit estimates a second distortion degree of the second end based on the difference between the second offset-measured value and the second position-measured value.

12. The dual-axis simultaneous motion system based on encoder compensation according to claim 11, wherein the control unit controls the first driver and the second driver to move in a steady state, and the first distortion degree and the second distortion degree tend to zero.

13. The dual-axis simultaneous motion system based on encoder compensation according to claim 11, wherein the control unit comprises a compensator receiving the first position-measured value and the second position-measured value, calculating the first distortion degree and the second distortion degree, and receiving a predetermined adjustment value, so as to control the first driver and the second driver.

14. The dual-axis simultaneous motion system based on encoder compensation according to claim 11, wherein the first-axis sliding module comprises a first-driver-position encoder, the second-axis sliding module comprises a second-driver-position encoder, and the control unit comprises a first main controller, a first position controller, a first speed controller, a second main controller, a second position controller and a second speed controller, wherein the first speed controller is connected to the first driver, and the first main controller is connected to the first encoder, the first-driver-position encoder and the second-driver-position encoder, wherein the first main controller drives the first speed controller according to a position difference obtained by the first-driver-position encoder and the second-driver-position encoder and the first position-measured value to control the first driver, wherein the second speed controller is connected to the second driver, the second main controller is connected to the second encoder, the first-driver-position encoder and the second-driver-position encoder, wherein the second main controller drives the second speed controller according to the position difference obtained by the first-driver-position encoder and the second-driver-position encoder and the second position-measured value to control the second driver.

15. The dual-axis simultaneous motion system based on encoder compensation according to claim 8, wherein the transverse beam comprises a first sleeve opening and a second sleeve opening disposed adjacent to the first end and the second end, respectively, wherein the first sliding block further comprises a first protrusion passing through the first sleeve opening, an inner ring of the first bearing is connected to the first protrusion, and an outer ring of the first bearing is connected to the first sleeve opening, wherein the second sliding block further comprises a second protrusion passing through the second sleeve opening, an inner ring of the second bearing is connected to the second protrusion, and an outer ring of the second bearing is connected to the second sleeve opening.

16. The dual-axis simultaneous motion system based on encoder compensation according to claim 8, further comprising a transverse sliding module including a third sliding block, a third sliding rail and a third driver, wherein the third driver drives the third sliding block to slide on the third sliding rail.
